(19) United States
(12) Patent Application Publication
(10) Pub. No.: US 2005/0177410 A1
(43) Pub. Date: Aug. 11, 2005

(54) Method to start a computer program

(76) Inventor: Trygve Engelbert, Stockholm (SE)

Correspondence Address: Alfred J Mangels, 4729 Cornell Road, Cincinnati, OH, 45241-2433, US

(21) Appl. No.: 10/504,493

(22) PCT Filed: Feb. 19, 2003
(86) PCT No.: PCT/SE03/00269

(30) Foreign Application Priority Data
Feb. 26, 2002 (SE) 0200567-6

(51) Int. Cl. G06F 17/60

(52) U.S. Cl. 705/10

(57) ABSTRACT

A method of starting a computer program where the program is stored in a memory belonging to a computer on which the program is to be used by a user. A first part of the program is stored in a primary memory of the computer in a first method step, wherein the first program part is the entire program with the exception of a smaller second part thereof. The primary memory requires the application of a voltage in order to retain information. The second part of the program is fetched from a source other than the source of the first part of the program in a second method step. The second part of the program is stored in the primary memory in a third method step, whereupon the program is complete and ready for use.

### BACKGROUND OF THE INVENTION

1. Field of the Invention

The present invention relates to method of starting a computer program.

2. Description of the Related Art

Computer programs are often distributed by means of diskettes, CD discs, or DVD discs, to the purchaser of a computer program, or to the purchaser of a license allowing the use of a computer program. Once the software has been installed, the program retailer normally has no control over the purchased software sample with regard to its use and its further distribution. It is often easy to duplicate the software or to install it in more computers than those included by a license, for example.

In the case of certain types of computer programs, it would be highly desirable to have control over the use of purchased software. For instance, it would be desirable know how many times the software has been used, or the total length of time that the software has been used, so as to obtain a basis on which the purchaser can be billed.

The present invention satisfies such desiderata, by enabling the use of software to be checked or controlled.

### SUMMARY OF THE INVENTION

Accordingly, the invention relates to a method of starting a computer program where the program is stored in a memory belonging to a computer on which the program is to be used by a user. The method involves storing in a primary memory of the computer in a first method step a first part of the program, wherein said first program part includes the whole of said program with the exception of a smaller second part thereof. The primary memory requires the application of a voltage in order to retain information. The second part of the program is fetched from a source other than the source of the first part of the program in a second method step. The second part of the program is stored in said primary memory in a third method step, whereupon the program is complete and ready for use.

### BRIEF DESCRIPTION OF THE DRAWING

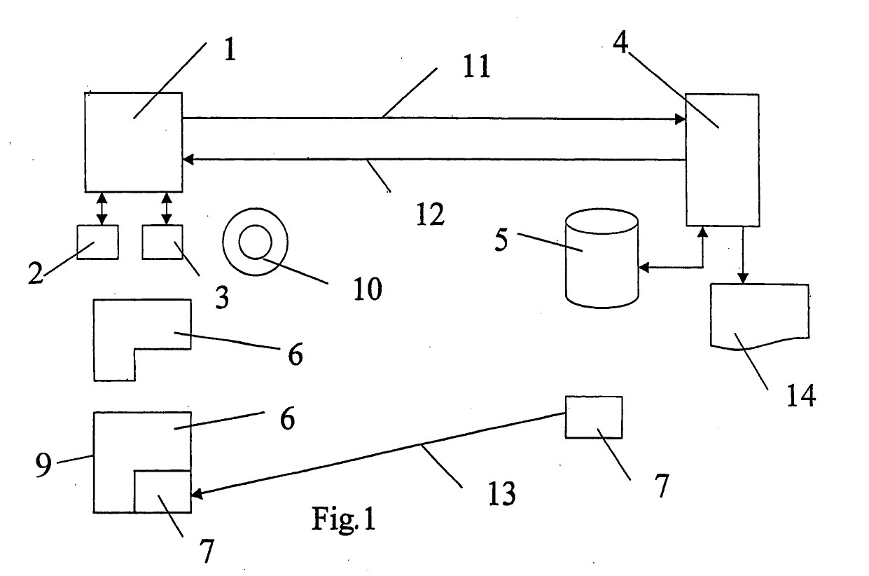

The invention will now be described in more detail partly with reference to an exemplifying embodiment thereof, and also with reference to the accompanying drawing, of which FIG. 1 is a block diagram that illustrates the inventive method.

### DESCRIPTION OF THE PREFERRED EMBODIMENTS

The method according to the invention relates to a manner of starting a computer program, wherein the program is stored in a memory belonging to a computer on which the program is to be run by a user.

Shown in FIG. 1 is a computer 1 on which the program is to be run. The computer includes a primary memory 2 and a secondary memory 3 in the form of a hard disc or its equivalent. The computer 1 may be a personal computer or a server.

Also shown is a server 4 or corresponding computer having an associated database 5. The database may be in the memory of the computer 4.

According to the invention, a first part 6 of the program to be run is stored in the primary memory 2 of the computer 1 in a first method step, wherein the primary memory is of the kind that requires the application of a voltage in order to retain information. Said first program part includes the whole of said program with the exception of a given smaller second part 7 thereof.

The second part 7 of the program is fetched from a source other than the source of the first part 6 of the program in a second method step.

This second part 7 of the program is stored in said primary memory 2 in a third method step, whereupon the program is ready for use. This is illustrated in FIG. 1 with the transfer of the second part 7 of the program to the first part 6 of the program as shown by the arrow 13, thereby completing the program.

The first part of the program is identified by reference numeral 6 in FIG. 1, and the second part of the program is identified by reference numeral 7. The complete program includes first part 6 and second part 7 and is represented by the full square 9.

It is preferred to store the first part 6 of the program in a memory 2 of the computer 1 prior to carrying out the second method step, said memory 2 being of the kind that will retain stored information without needing to apply a voltage, such as a hard disc or its equivalent.

In the first step of the invention, the first part 6 of the program is stored in the primary memory 2 of the computer 1. This can be effected from the secondary memory 3 of the computer 1 or from a portable data storage medium, such as a diskette, or a compact disc 10, or in some other suitable fashion.

In the second method step, the second part 7 of the program is fetched from a source other than the source from which the first part 6 of the program was taken.

According to one preferred embodiment of the invention, the second part 7 of the program is fetched from a server 4, or from another computer that is separate from the computer 1, via the Internet or some other information transfer medium. This second part 7 of the program can be fetched via a wired or wireless transfer medium, as represented by arrows 11, 12 in FIG. 1.

According to a highly preferred embodiment of the invention, the program 6, 7 is configured so that said second part 7 of the program need be stored only in the primary memory 2.

Because the complete program is stored in the primary memory 2, the entire program will be lost when the user exits from the program or switches off the computer 1. In order to be able to use the program again, it is necessary to repeat the above-described three method steps. It thus possible to store in the server information disclosing the number of times that the program has been activated. The second part 7 of the program can be any suitable part of the overall program. For example, it may consist of program instructions, strings, parts of figures, or other information without which the user is unable to use the program. The second part 7 of the program is thus configured so that the program 9 cannot be used without it.

According to one preferred embodiment of the invention, a code is sent from the computer 1 to the server 4, as indicated by the arrow 11, to enable the second part 7 of the program to be fetched. The second part 7 of the program is transferred, once the code has been validated by the server 4, as indicated by the arrow 12.

The code identifies a user. The owner of the code will suitably acquire the code when permission to use the program is given.

For example, a user can acquire the right to use the program for a number of times or over an agreed calendar period.

In respect of the second step of the invention, in which the second part of the program is fetched from a different source, it is preferred to store the code in the server 4 and to pair the code with the code owner. This enables the code owner to be billed from the server 4, as illustrated by the print-out 14.

Although the invention has been described with reference to a number of embodiments thereof, the person skilled in this art will be aware that modifications can be made.

The present invention is not therefore to be considered to be limited to said embodiments, since modifications can be made within the scope of the accompanying claims.

1. A method of starting a computer program wherein the program is to be stored in a memory belonging to a computer on which the program is to be used by a user, where a said method comprising the steps of: obtaining a first Part of the program; storing the first part of the program in a primary memory of the computer in a first method step, wherein said first program part is a complete program with the exception of a smaller second part thereof, and wherein the primary memory requires the application of a voltage to retain information to be stored therein; fetching said second part of the program fetched from a source other than that from which the first part of the program is obtained in a second method step; and storing said second part of the program only in said primary memory in a third method step, whereupon the program is complete and ready for use.

2. A method according claim 1, including the step of storing the first part of the program in a secondary memory of the computer prior to carrying out the first method step, wherein said secondary memory retains stored information without a need to apply a voltage to retain information stored therein.

3. A method according claim 1, wherein said first part of the program is provided on a portable data medium.

4. A method according claim 1, wherein said second part of the program is fetched from a server that is separate from the computer used by the user.

5. A method according claim 1, wherein the source of the second part of the program is a server, and including the step of transferring from the computer to the server a code for enabling fetching of said second part of the program.

6. A method according claim 5, including the steps of storing the code in the server when carrying out the second method step in which the second part of the program is fetched; and pairing the code with the user.

7. A method according to claim 2, wherein the secondary memory is a hard disk.

8. A method according to claim 3, wherein the portable data medium is a diskette.

9. A method according to claim 3, wherein the portable data medium is a compact disk.

10. A method according to claim 1, wherein said second part of the program is fetched from a second computer.

11. A method according to claim 1, wherein said second part of the program is fetched from the Internet.
